(19) United States
(12) Patent Application Publication
(10) Pub. No.: US 2024/0289529 A1
(43) Pub. Date: Aug. 29, 2024

(54) METHOD FOR CELL LAYOUT

(71) Applicant: Tokyo Electron Limited, Tokyo (JP)

(72) Inventors: Jeffrey Smith, Albany, NY (US); David Power, Albany, NY (US); Anton deVilliers, Albany, NY (US)

(21) Appl. No.: 18/586,249

(22) Filed: Feb. 23, 2024

Related U.S. Application Data
(60) Provisional application No. 63/447,968, filed on Feb. 24, 2023.

(51) Int. Cl. G06F 30/392; G06F 30/398; G06F 119/02

(52) U.S. Cl. CPC G06F 30/392; G06F 30/398; G06F 2119/02

(57) ABSTRACT

A method of designing a standard cell layout includes determining a performance metric for the standard cell layout and executing an artificial intelligence (AI) algorithm. The executing of the AI algorithm includes extracting out a parameter of the standard cell layout having a different weighting with respect to optimizing the performance metric, adjusting the parameters of the standard cell layout, evaluating the performance metric based on the adjusted parameter of the standard cell layout, and continuing to adjust the one or more parameters until the performance metric reaches a desired value.

### CROSS-REFERENCE TO RELATED APPLICATIONS

This application claims the benefit of U.S. Provisional Application No. 63/447,968, filed on Feb. 24, 2023, which application is hereby incorporated herein by reference in its entirety. This application is related to U.S. patent application Ser. No. 17/219,539, entitled “Method for Automated Standard Cell Design,” and filed on Mar. 31, 2021, now U.S. Pat. No. 11,714,945 issued on Aug. 1, 2023, which is a continuation-in-part of U.S. patent application Ser. No. 17/122,689, entitled “Method for Automated Standard Cell Design,” and filed Dec. 15, 2020, now U.S. Pat. No. 11,550,985 issued on Jan. 10, 2023, which claims the benefit of U.S. Provisional Application No. 63/007,705, entitled “Method for Automated Standard Cell Design,” and filed on Apr. 9, 2020, which applications are hereby incorporated herein by reference in their entireties.

### TECHNICAL FIELD

The present invention relates generally to microelectronics, and, in particular embodiments, to a system and method for designing transistor cells.

### BACKGROUND

U.S. Pat. No. 11,550, 985 (“Liebmann”), titled “Method for Automated Standard Cell Design,” which is incorporated herein by reference, describes a method in which logic standard cell layouts can be automatically generated through a given circuit net-list. This method incorporates elements from a Technology File (TF), Process Assumption List (PAL), and/or Process Design Kit (PDK) as well as a starting device architecture (such as FinFET, gate-all-around (GAA), or complementary FET (CFET)). In this method, a number of permutations can be decomposed in which several electrically-valid circuit layouts can be provided which meet all of the criteria set out by the TF, PAL, and/or PDK. Liebmann describes in detail how this is accomplished through a computational method based on taking the incoming circuit netlist and decomposing it to a series of common and unique transistors or “gates” with their corresponding input connections, a series of contacts and their corresponding connections to either power (V_{DD}) or ground (V_{SS}), as well as to desired output lines or “tracks” and to any intermediate signal connections shared within the standard cell.

Integrated circuits may include one or more types of transistors. Planar transistors are a very common transistor technology. Planar transistors are manufactured using a conventional planar (layer by layer) manufacturing process and in which the transistor junctions reach the semiconductor surface in one plane. For example, FIG. 1 illustrates exemplary planar transistor 100.

Non-planar transistors, also referred to as three-dimensional (3D) transistors, are transistors in which the transistor junctions reach the semiconductor surface in different planes, such as a raised source-to-drain channel, e.g., as exemplified by a Tri-Gate transistor, or a raised channel (called fin) from source to drain, e.g., as exemplified by a fin field-effect-transistor (FET) (FinFET). A FinFET has the gate placed on two, three, or four sides of the channel, or wrapped around the channel, forming a double gate structure. FIG. 2A and 2B illustrates exemplary 3D Tri-Gate transistor 200, and FinFET 250.

Another example of non-planar transistor is the nanosheet (NS) transistor (also known as lateral gate all around (LGAA) transistor. FIG. 3 illustrates exemplary NS transistor 300.

Complementary FET (CFET) is another type of non-planar, 3D transistor in which, e.g., two FETs (e.g., an nFET and a pFET) are stacked vertically, with a vertical common gate that form horizontal channels. For example, FIG. 4 illustrates exemplary CFET 400. As can be seen from FIG. 4, CFETs have the advantage of resulting in simplified access to the FET terminals, which can result in smaller layouts.

FIG. 5 illustrates exemplary vertical transistor (VFET) 500, in which source-gate-drains of each transistor are stacked vertically. VFETs are referred to as vertical transistors because the channel is vertical, as illustrates in FIG. 5.

FIG. 6 illustrates a 3D view of an exemplary wire track plan for non-stacked FinFETs. As illustrates in FIG. 6, the track plan includes 4 signal tracks (636, 638, 640 and 642). Signal tracks 634 and 636 may be used to route the gate or a source/drain of the pFET using a contact. Signal tracks 640 and 642 may be used to route the gate or a source/drain of the nFET using a contact. It is understood that the 3D view illustrated in FIG. 6 is a non-limiting example that corresponds to a specific arrangement of devices in the track plan and that the placement of, e.g., contacts and other connections may be different, may connect different nodes or be omitted depending on the particular connections to be made.

FIGS. 7A and 7B illustrate a 3D view of an exemplary wire track plan for a single stack of CFETs.

In the track plan illustrated in FIGS. 7A and 7B, pFETs are capable of connecting to tracks 634 and 636 and nFETs are capable of connecting to tracks 640 and 742 when implemented in the configuration shown in FIG. 7A, and nFETs are capable of connecting to tracks 734 and 736 and pFETs are capable of connecting to tracks 740 and 742. As illustrated in FIGS. 7A and 7B, the track plan for CFETs is also capable of connecting source/drains without the use of a contact by routing horizontally in the layer where the source/drain is located using one of the two layers of local interconnects.

FIG. 8 illustrates a 3D view of an exemplary wire track plan for 2-tier stacked CFETs. As shown in FIG. 8, the track plan includes 4 top signal tracks (734, 736, 740, and 742) and 2 bottom signal tracks (748 and 756). Signal tracks 734 and 736 may be used to route the top-tier gate or a source/drain of the top-tier nFET using a contact. Signal tracks 740 and 742 may be used to route the top-tier gate or a source/drain of the pFET using a contact. Signal track 748 may be used to route the bottom-tier gate or a source/drain of the bottom-tier pFET using a contact. Signal tracks 756 may be used to route the bottom-tier gate or a source/drain of the nFET using a contact. The top-tier gate may be connected to the bottom-tier gate by eliminated (e.g., not forming) the insulator layer between the top-tier and bottom-tier gates. It is understood that the 3D view illustrated in FIG. 8 is a non-limiting example that corresponds to a specific arrangement of devices in the track plan, and that the placement of the devices may be changed (e.g., pFETs and nFETs may be flipped), e.g., and that connections may be different (e.g., flipped).

### SUMMARY

In accordance with an embodiment, a method of designing a standard cell layout includes determining a performance metric for the standard cell layout and executing an artificial intelligence (AI) algorithm, the executing of the AI algorithm including: extracting out a parameter of the standard cell layout having a different weighting with respect to optimizing the performance metric; adjusting the parameters of the standard cell layout; evaluating the performance metric based on the adjusted parameter of the standard cell layout; and continuing to adjust the one or more parameters until the performance metric reaches a desired value.

In accordance with another embodiment, a method of designing a transistor device includes receiving data representative of a first transistor device; converting the data into a first three-dimensional model, the model including: a plurality of parameters representing locations and dimensions of features of the first transistor device; and a first figure of merit representing at least one of power, performance, area, and cost; optimizing the first figure of merit by adjusting one or more of the plurality of parameters using an artificial intelligence (AI) algorithm; and generating a second three-dimensional model by applying the parameters of the plurality of parameters adjusted by the AI algorithm to the first three-dimensional model, the second three-dimensional model being representative of a physical manifestation of a second transistor device.

In accordance with yet another embodiment, a method of designing a standard cell layout includes: receiving a first netlist, the first netlist corresponding to a library of standard cells for designing a given chip; converting the first netlist into a standard cell layout file including one or more constraints from a process design kit, the process design kit being configured to model a semiconductor fabrication process; executing a simulation of a standard cell and device modeled as a three-dimensional representation with the standard cell layout file; based on the simulation, generating a second netlist having values for parasitic resistance-capacitance; and executing a ring oscillator simulation using the second netlist, the ring oscillator simulation generating a performance metric that includes at least one of power, performance, area, and cost for a corresponding integration flow.

It is to be understood that both the foregoing general description and the following detailed description are exemplary and explanatory only and are not restrictive of the disclosure, as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an exemplary planar transistor;

FIG. 2A illustrates an exemplary 3D Tri-Gate transistor;

FIG. 2B illustrates an exemplary FinFET;

FIG. 3 illustrates an exemplary nanosheet (NS) transistor;

FIG. 4 illustrates an exemplary complementary FET (CFET);

FIG. 5 illustrates an exemplary VFET;

FIG. 6 illustrates an exemplary wire track plan for non-stacked FinFETs;

FIGS. 7A and 7B illustrate a 3D view of an exemplary wire track plan for a single stack of CFETs;

FIG. 8 illustrates an exemplary wire track plan for 2-tier stacked CFETs;

FIG. 9 illustrates a 3D view of an exemplary CFET, in accordance with some embodiments;

FIG. 10 illustrates a 3D view of an exemplary CFET, in accordance with some embodiments;

FIG. 11 illustrates a 3D view of an exemplary CFET, in accordance with some embodiments;

FIG. 12 illustrates a block diagram of an example machine learning (ML) system, in accordance with some embodiments;

FIG. 13 illustrates a diagram of an example neural network, in accordance with some embodiments;

FIG. 14 illustrates a process flow chart diagram of a method of designing a standard cell layout, in accordance with some embodiments;

FIG. 15 illustrates a process flow chart diagram a method of designing a transistor device, in accordance with some embodiments; and

FIG. 16 illustrates a process flow chart diagram of a method of designing a standard cell layout, in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Embodiments of the present disclosure provide artificial intelligence-based techniques for automating the creation and improvement of logic standard cell layouts incorporating simulated power, simulated performance, simulated area, and simulated cost output metrics. Embodiments of the present disclosure refine the function-of-merit of the generated standard cell to a full ring-oscillator (RO) power, as well as power consumption, performance, area, and cost, known as a PPAC assessment. This RO-PPAC assessment is used to provide further function-of-merit for a given electrically viable standard cell layout. The RO-PPAC assessment herein may provide a training vehicle for a machine learning algorithm in which commonly used functions-of-merit such as wire length, total metal FEOL/MOL (front end of line/middle of line) metal volume, total area, et cetera can be correlated to simulated RO-PPAC that accelerates improvement of a standard cell layout. Embodiments of the present disclosure identify a full parameterization set for the ability to incorporate an Al component to challenge assumptions in the standard cell layout considered obvious, to create novel approaches to standard cell layouts, and to allow for an evolutionary approach to standard cell design.

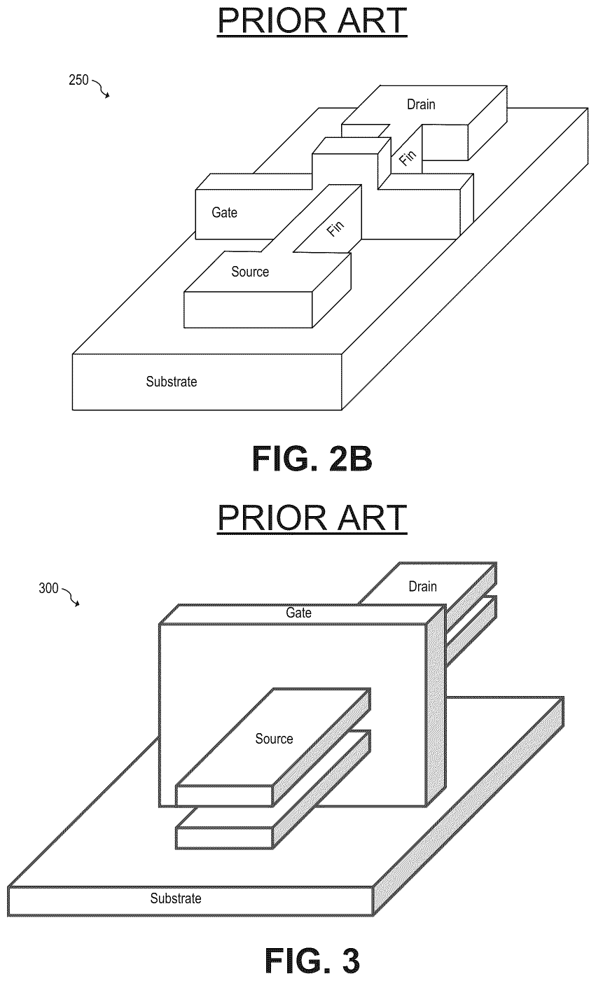

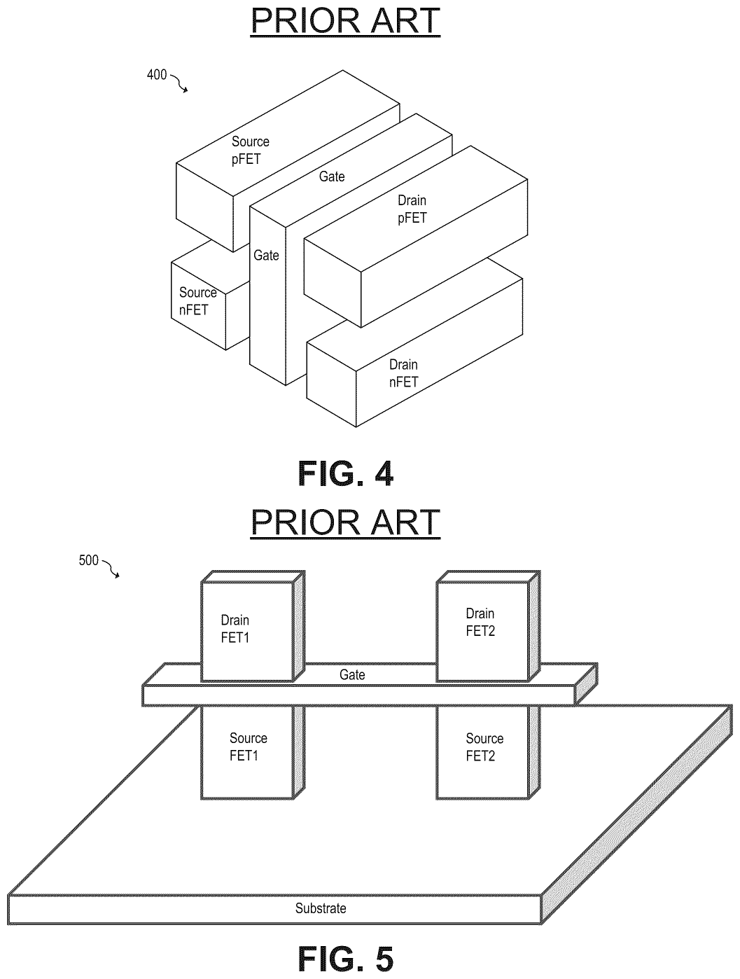

A current manual approach to standard cell generation may typically follow a flow-path in which one initially places a channel at a width and number by the TF, PAL, and/or PDK distributed appropriately within the confines of the standard cell border. A conventional practice is to have the channel run within an east-to-west orientation. For a FinFET (see above, FIGS. 2A-2B) this could be represented by a population of both NMOS and PMOS fins, in which the fins can have cuts placed in them to form diffusion breaks either at the cell boundaries or even within the cell itself. For a gate-all-around (GAA) FET (see above, FIG. 3), the channel widths will be larger. Nevertheless, the population of NMOS and PMOS active areas in a GAA FET device consuming standard cell area can be made smaller because the channels will be vertically stacked on top of one another. For complementary FET (CFET) devices (see above, FIG. 4), the NMOS and PMOS channels are stacked overtop of one another. This may allow for even greater ability to size the channels as desired and to have significant compression of the area of the standard cell.

Because connections for three-dimensional device architectures are no longer limited to an east-west type of configuration, device architecture may have a significant impact on how the standard cell is laid out. Furthermore, device architecture can now also access up and down connections to different device planes, such as what would be done with a complementary FET (CFET) device.

As an example of a conventional process, a V_{DD} power and V_{SS} ground connection are placed as a rail on both the northern-most and southern-most boundaries of a standard cell. However, this process is not necessarily fixed and is included as an example of a typical process. From this initial setup, PMOS contact and interconnect connections are then added from the circuit design. The PMOS contact and interconnect connections are made to the V_{DD} source through an orthogonally-placed metal interconnect (which will run in the north-south orientation), where they will intersect between the V_{DD} power supply and the channel structure or structures. In current integrations, the V_{DD} power rails may exist under the device plane in what is known as back-side power distribution networks (BSPDN) or may exist as a metal line in the traditional back-end-of-the-line (BEOL) plane located above the device plane. Placing the power supply lines under the active device may be advantageous because it allows for more signal and routing tracks in the BEOL plane and/or allows for compression of the standard cell in terms of area if an adequate number of signal and routing tracks already exist.

Common and unique PMOS gates are then placed where they may be connected adjacent to a source interconnect and contact supplying power from the V_{DD} connection. Typically, the gates may likewise run in the north-south orientation, similar to the interconnect metal structures in common practice. However, this choice is arbitrary and standard cells may be designed with the opposite orientation. The output of the PMOS and common transistors are then made by drawing another interconnect structure through which that connection can be routed. This output may be either as a source for the next-in-line transistor, to an output line existing on the BEOL plane, or to an intermediate signal line which may either be used to supply an input to another transistor or as a supply source for an interconnect. Additionally, in some constructs it is possible for the signal lines to be placed under the active device.

This process may then be repeated for NMOS gates in a similar fashion in which the ground connections are made to V_{SS} and the appropriate gates are placed with connections to the ground on one side and connections to the output tracks or internal routing tracks on the opposite sides of the gates.

Next, via connections are placed along the signal tracks to make connections to the transistors and interconnect structures for internal routing, output routing, input routing, and power routing. The metal signal wires will then connect to these vias to enable connections to input, output, power, and internal routing within the standard cell as well as between standard cells when higher-level metal wires are used.

The placement of the transistor and interconnect structures are done so that common gates connecting both NMOS and PMOS to a common input signal are placed with desired connections to the desired interconnects. Unique NMOS and PMOS transistors can be placed so that connections to their corresponding interconnects can be made. Additionally, diffusion breaks can be placed at appropriate placements within the standard cell. The number of permissible power and routing tracks can be defined by the TF, PAL, and/or PDK as an area constraint. The standard cell can also be varied so that certain trade-offs are permissible. For example, power rails may be moved down below the surface of the device plane so that a wider number of routing tracks can be used in the standard cell input/output/internal routing connections. Power can then be tapped by making downward connections to V_{DD} and V_{SS}.

For each of the successful permutations, various function-of-merits can be derived from the given final layout solution to grade the quality of the layout design. For example, such function-of-merits include the overall size or area of the standard cell, the wire length of the initial metal layer tracks, and the size of the total metal used in the interconnect and metal gate structures. The wire length of the initial metal layer tracks may correlate to wire resistance and back-end-of-the-line (BEOL) capacitance, and the size of the total metal used in the interconnect and metal gate structures may correlate to front-end-of-the-line (FEOL) capacitance of the device.

This approach can then be applied to an entire library of different standard cells, which can comprise hundreds of unique standard cells. In this approach, a common denominator or multiple common denominators can be determined in which a given cell size or sizes can be decomposed to fit the entire cell library. For example, high-density standard cells may function by accessing a smaller number of routing tracks compared to high density cells. In this example, the standard cell library can be broken into multiple groups to reflect this with both groups comprising slightly different rules. Likewise, high-density standard cells may be able to operate with a reduction in Fin populations compared to high performance standard cells. This may be advantageous by leading to significant cell area compression.

An automation can run through permutation of electrically valid standard cell layouts for any given netlist, incorporating elements of a TF, PAL, and/or PDK and set device architecture to come up with a number of electrically viable layouts that can be further refined to those that meet some level of merit such as minimum wire length, minimum total metal volume in the gates and/or interconnects, minimum area, et cetera. These function-of-merit results may be extracted from the standard cell generated and no advanced device-level simulation is needed for any further improvement.

Techniques disclosed herein provide artificial intelligence-based (AI-based) techniques for automating the creation and improvement of logic standard cell layouts incorporating simulated power, simulated performance, simulated area, and simulated cost output metrics. Techniques disclosed herein refine the function-of-merit of the generated standard cell to a full ring-oscillator (RO) power, as well as performance, area, and cost, known as a PPAC assessment. This RO-PPAC assessment is used to provide further function-of-merit for a given electrically viable standard cell layout. The RO-PPAC assessment herein provides a training vehicle for an AI algorithm (e.g., a machine learning algorithm) in which commonly used function-of-merits such as wire length, total metal FEOL/MOL (front end of line/middle of line) metal volume, total area, et cetera can be correlated to simulated RO-PPAC that accelerates improvement of a standard cell layout. Techniques herein identify a full parameterization set advantageous for allowing an artificial intelligence (AI) component (e.g., a machine learning algorithm or the like) to challenge assumptions in the standard cell layout considered obvious, to create novel approaches to standard cell layouts, and to allow for an evolutionary approach to standard cell design.

To assess RO-PPAC, a software platform called the Technology Prototyping System (TPS) quantifies a finalized circuit (e.g., a ring-oscillator) power/performance/area/cost assessment for any given standard cell in which any manually or automated circuit layout could be taken and run through a fixed process integration flow to produce a three-dimensional simulation of the standard cell, complete with material identification with known electrical properties of each material. From this three-dimensional representation a parasitic resistance and capacitance model can be extracted directly from known material properties, allowing an extracted parasitic netlist to be created. A device model for the transistor can be derived based on the TF, PAL, and/or PDK for this given device. This device model may be combined with the parasitic netlist to generate a plan for building a ring oscillator in order to quantify the power and performance of the given standard cell. The standard cell layout may also contain components and ground-rules extracted from the TF, PAL, and/or PDK. The area component of the PPAC analysis can be derived directly from these components and ground-rules. The cost component of the PPAC analysis can be derived through the process integration model used to generate the three-dimensional structure of the circuit (e.g., a ring-oscillator or any suitable circuit). Any given integration flow and change to that flow may be calculated in terms of wafer processing costs.

The final output of this simulation may be a power/performance/area/cost metric (e.g., an ring oscillator-based metric) across a slew of different supply voltages. These different supply voltages can be factored into any metric using any of these terms. For example, the metric of merit may be performance-as-a-function-of-cost or anything which can be derived from the PPAC numbers.

Exemplary aspects of the flow of the Technology Prototyping System (TPS) platform will now be described. An incoming netlist may be provided by a designer across a library of different intended standard cells for which this library may be used to construct the chip design. The netlist is then converted to an improved standard cell layout, which may be expressed as a .gds or .oas file. However, any suitable file formats may be used. In various embodiments, this improvement is applied to function-of-merit parameters such as minimal BEOL wire lengths, minimal interconnect and gate volumes for FEOL/MOL, minimal cell area, or the like.

The improved standard cell layout is also constrained through an incoming TF, PAL, and/or PDK file. The incoming TF, PAL, and/or PDK file can include details/constraints such as contacted poly pitch (CPP), the size of the transistors, the total effective width of the transistors, the desired effective oxide thickness, the set interconnect width, the size of any via connections, the size and width of the metal lines in the BEOL, the amount of extensions for vias connecting to the metal lines, the minimum tip-to-tip distances of adjacent structures, the allowable dielectric separation of metal structures, et cetera. As can be appreciated, there are many more parameters/constraints beyond the examples listed that can be applied to the final standard cell layout.

A base process integration flow based on a given device architecture is then used along with the layout file to produce a simulation of the actual device (e.g., an RO simulation, or in other words a cell-level ring oscillator simulation from which we can extract power and performance as a mean of characterizing the layout performance), the dimensions and rules associated with the layout file and TF, PAL, and/or PDK, ranges of suitable materials to be used for the semiconductor, the metal structures, and surrounding dielectric materials, and appropriate estimations of the individual unit process capabilities of each of the steps in the step-by-step build of the semiconductor device. Process integration may be done manually using known, state-of-the-art unit processes involving, but not limited to, lithography, etch, deposition, annealing, implantation, and so forth. Suitable software can be used with a starting input layout file and a starting integration to generate these three-dimensional device structures. Such process integrations can have a number of steps in a range of, for example, 100 steps to 1000 steps, depending on the complexity of the device and how such a device can be manufactured with current state-of-the-art processing.

This software also allows for multiple iterations of any given process integration flow. In other words, ground-rules within an established TF, PAL, and/or PDK can be challenged through what are known as design-technology co-improvement (DTCO) solutions. For example, a given standard cell layout can be run across different iterations of a given process integration, or even an entirely different device architecture integration, to provide several RO-PPAC solutions.

From these integration models, a step-by-step wafer cost assessment can be made for any given integration flow. These models have been where a detailed wafer cost-by-step can be used and incorporated back into the process emulation file.

Next, an extraction may be performed on the three-dimensional model of the semiconductor device, in which the different parasitic resistances and capacitances are quantified through a direct field-solver approach using assumptions of the materials and their electric properties contained within the process emulation model. This can be done by any suitable software known in the industry. The software may be bridged to the integration process emulation to provide a continuous loop of integration to parasitic resistance/capacitance (RC) extraction. This bridging may further provide extraction of a netlist directly from the three-dimensional model, which may be advantageous for checking that the integration flow is valid and provides a matched generated netlist to the incoming netlist used in the construct of the standard cell layout file.

A technology computer aided design (TCAD) device model may then be built for the semiconductor device (e.g., a transistor) using either the TF, PAL, and/or PDK or from the extraction done through the integration model. Parameters may be added to the device model that are derived through the three-dimensional integration model. These parameters may include, for example, quantification of strain along the channel based on the contact epitaxial volume and merging, the composition of the channel, and the metal and material properties used in the contact interconnect structure. The strain on the channels may be provided, for example, by the user based on known state-of-the-art methods today and demonstrated on actual test devices. Additionally, variability of the device may be determined with Monte Carlo solvers. For example, a Monte Carlo solver may which variability of channel parameters such as effective gate length or variations in channel width can be interpolated in contrast to having to be fully re-solved. Additionally, other parameters can be reset within the model to match to experimental measurements, such as leakage.

The combination of the TCAD device models and the extracted RC netlist can be used to then run simulations on a ring oscillator device in which power and performance across a swatch of different supply voltage conditions.

Thus, for any given circuit layout, a final RO-PPAC metric including power and performance (also referred to as a performance metric) can be extracted from the TPS platform. Concurrently, the estimated wafer processing cost can be derived through the integration model and the area of the standard cell through the automatically generated layout file based on the incoming TF, PAL, and/or PDK file.

Embodiments disclosed herein include current feed-back loops of the finalized RO-PPAC metrics back into the further improvement of the standard cell. Techniques herein include a method that extends the automated standard cell generation in which this capability is used to generate RO-PPAC metrics as a function-of-merit for a given standard cell layout. In other words, instead of using generic metrics such as wire minimization, area minimization, interconnect and gate metal volume reduction, which can be extracted from the generated .gds or .oas file, the output includes a cost-of-function metric derived through the full simulation of the device through RO-PPAC.

These embodiments include a permutation-based approach where each electrically valid layout is then run through the TPS platform to extract an RO-PPAC metric. This RO-PPAC metric may then be further adjusted to suit desired parameters of an end-user (such as, for example, cost-per-performance or performance-as-function-of-power).

In accordance with an embodiment, a method includes using common constraints that may be excluded from a TF, PAL, and/or PDK in common practice. These constraints can be incorporated in the method as levers to further refine standard cells through an AI-assisted methodology (e.g., a machine learning algorithm). The parameters that are challenged (or in other words, varied by the AI algorithm) may be parameters that are commonly seen in the art as “locked” setpoints or something for which adjusting or challenging does not provide an obvious advantage. An example of this would be a simplistic assumption that a standard cell is composed of a single cell and that the standard cell is not allowed to extend into a second cell. However, there may be significant benefits in the cell library to shrinking the standard cell to a very narrow cell height in which high-density cells can exist without conflict and in which high performance cells for which additional cell height is desirable are able to extend into a second discrete cell neighboring the high performance cell.

Using the AI algorithm to test or challenge the constraints may provide a much faster capability to discover new and better configurations than may be efficient or possible for a human designer, due to the computer-based AI algorithm's far greater speed and efficiency in comparison with a human. In other words, the use of the AI algorithm provides capabilities that are impossible for a human to provide in the refinement of standard cell plans.

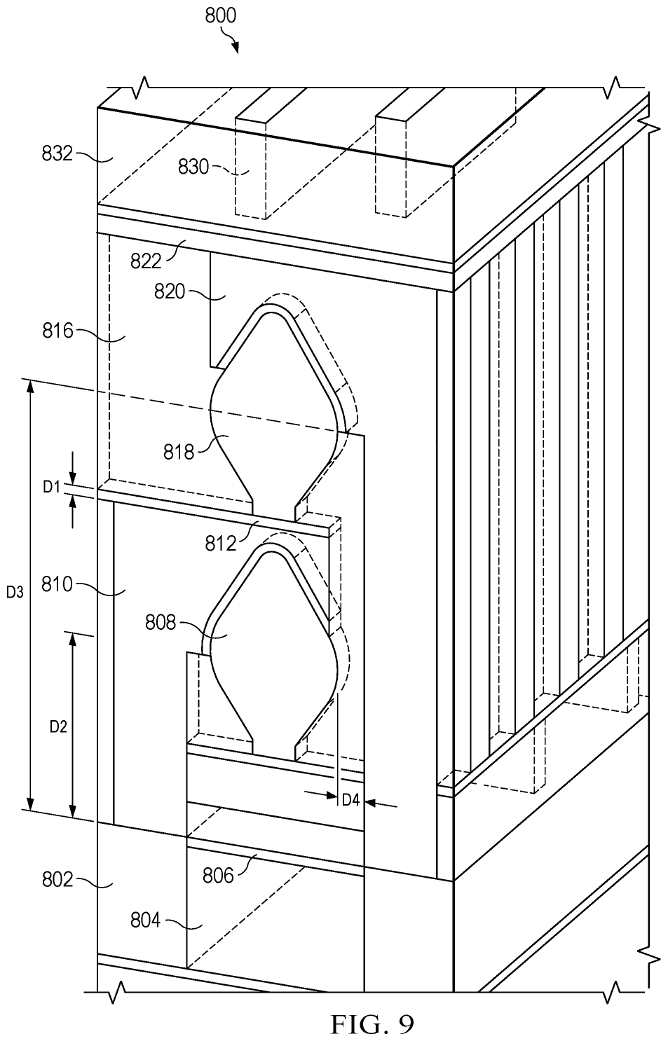

FIGS. 9 through 11 illustrate various exemplary CFET devices with integration parameters that may be improved by an AI algorithm, in accordance with various embodiments. Although the CFET devices illustrated by FIGS. 9 to 11 are monolithic CFETs, the integration parameters illustrated may also be applied to sequential CFETs or to any other CFET or similar device, and all such embodiments are within the scope of the disclosure.

FIG. 9 illustrates a 3D view of an exemplary CFET 800 showing source/drain region to power rail couplings, in accordance with some embodiments. A lower source/drain region 808 is over an interconnect structure comprising power rails 802 (e.g., V_{DD} and/or V_{SS}) disposed in insulating layers 804. The lower source/drain region 808 comprises silicon, silicon-germanium (SiGe), or the like, and may be formed with epitaxial growth or another suitable process. In some embodiments, the lower source/drain region 808 is covered by a silicide region. The power rails 802 comprise a conductive material such as a metal, e.g., copper (Cu) or the like. The insulating layers 804 comprise a suitable dielectric material, such as an oxide (e.g., silicon oxide, silicon dioxide, or the like). In some embodiments, one or more of the insulating layers 804 are covered by respective etch stop layers 806 comprising a suitable material such as a nitride (e.g., silicon nitride).

A lower contact 810 extends up from a power rail 802 and over the lower source/drain region 808 to couple with the lower source/drain region 808 and thereby form a power connection. In some embodiments, the lower contact 810 comprises a conductive material such as a metal, e.g., ruthenium, tungsten, cobalt, the like, or a combination thereof.

A top surface of the lower contact 810 is covered by a cap layer 812 that comprises a dielectric material such as silicon carbide (SiC), silicon carbonitride (SiCN), or the like. The cap layer 812 electrically isolates the lower source/drain region 808 from the upper source/drain region 818, which is formed over or on the cap layer 812. The upper source/drain region 818 may be formed using similar methods and materials as the lower source/drain region 808, and the details are not repeated herein. In some embodiments, the lower source/drain region 808 is a pFET source/drain region and the upper source/drain region 818 is an nFET source/drain region. In other embodiments, the upper source/drain region 818 is a pFET source/drain region and the lower source/drain region 808 is an nFET source/drain region.

An upper contact 820 extends up from a power rail 802 and over the upper source/drain region 818 to couple with the upper source/drain region 818 and thereby form a power connection. The upper contact 820 may be formed using similar methods and materials as the lower contact 820, and the details are not repeated herein.

Remaining space between and around the lower source/drain region 808, the lower contact 810, the upper source/drain region 818, and the upper contact 820 may be filled with a dielectric layer 816. In some embodiments, the dielectric layer 816 comprises a dielectric material such as an oxide (e.g., silicon oxide or silicon dioxide), a nitride (e.g., silicon nitride), a low-k dielectric such as silicon oxycarbide or the like, or a combination thereof. However, any suitable materials may be used to form the dielectric layer 816.

A top surface of the upper contact 810 and the dielectric layer 816 is covered by a cap layer 822 that comprises a dielectric material such as silicon carbide (SIC), silicon carbonitride (SiCN), or the like. The cap layer 812 electrically isolates the upper source/drain region 818 from one or more signal lines 830 formed over or on the cap layer 812. The signal lines 830 may comprise a similar material as the power rails 802 or the lower contact 810, and the details are not repeated herein. The signal lines are disposed in insulating layers 832, which comprise a suitable dielectric material, such as an oxide (e.g., silicon oxide, silicon dioxide, or the like). In some embodiments, one or more of the insulating layers 832 are covered by respective etch stop layers (not illustrated) comprising a suitable material such as a nitride (e.g., silicon nitride).

FIG. 9 illustrates several integration parameters D1, D2, D3, and D4 that may be improved upon by an AI algorithm working to improve PPAC metrics. Distance D1 is the vertical spacing between the n and p tiers of the CFET 800, which may be the thickness of the cap layer 812 and may determine capacitance between neighboring device tiers (in other words, between stacked nFETs and pFETs). Distance D2 is the length of a vertical portion of the lower contact 810 that couples to a power rail 802 and may determine the resistance of tier-to-tier connections. Distance D3 is the length of a vertical portion of the upper contact 820 that couples to a power rail 802 and may determine the resistance of tier-to-tier connections. Distance D4 is the spacing between the lower source/drain region 808 and the vertical portion of the upper contact 820 (in other words, the complementary via-to-backside power). Other integration parameters such as the widths of contact portions may also be varied.

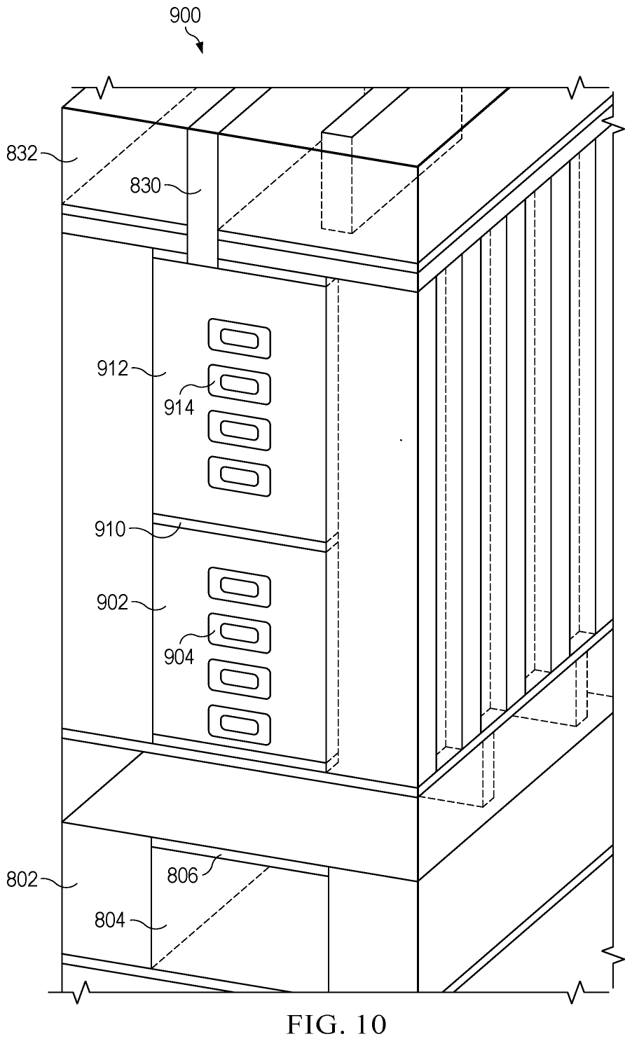

FIG. 10 illustrates a 3D view of an exemplary CFET 900 showing gate to power rail couplings, in accordance with some embodiments. The structure illustrated by FIG. 10 is similar to the structure illustrated by FIG. 9 but with gate-all-around (GAA) structures replacing the source/drain regions, and descriptions of like elements are not repeated herein. A stack of lower nanostructures 904 are over interconnect layers comprising power rails 802 and insulating layers 804. Each lower nanostructure 904 comprises a channel region (e.g., a nanosheet, a nanowire, or other nanostructure comprising silicon) covered by a respective gate dielectric layer that surrounds each channel region as shown in a cross-sectional view. The stack of the lower nanostructures 904 are covered by a lower gate electrode 912, which comprises a suitable conductive material such as a metal.

A stack of upper nanostructures 914 is over the stack of lower nanostructures 904 and is covered by an upper gate electrode 912. In some embodiments, the lower gate electrode 902 and the upper gate electrode 912 are separated by a middle layer 910, which may comprise a conductive material (e.g., a metal) from the upper gate electrode 912 that wraps around the nanostructures and is also deposited conformally on a floor below the upper gate electrode 912 (e.g., a top surface of the lower gate electrode 902). In other embodiments, the middle layer 910 comprises a dielectric material to electrically isolate the upper and lower gates. A signal line 830 may couple with the upper gate electrode 912. In some embodiments, the lower nanostructures 904 are part of a pFET and the upper nanostructures 914 are part of an nFET. In other embodiments, the lower nanostructures 904 are part of an nFET and the upper nanostructures 914 are part of a pFET.

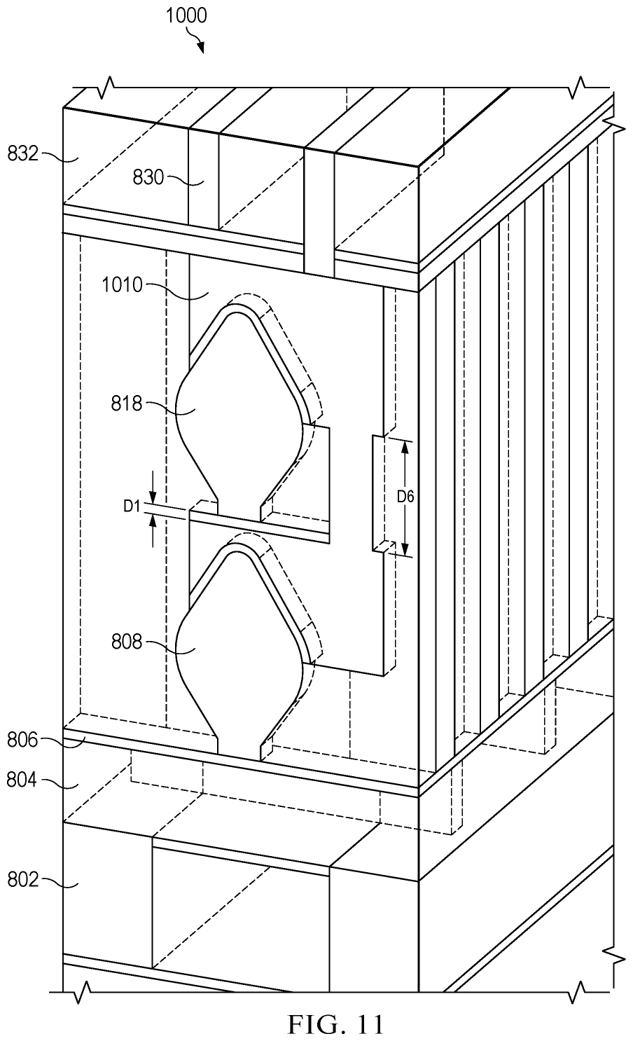

FIG. 11 illustrates a 3D view of an exemplary CFET 1000 showing source/drain region to signal line couplings, in accordance with some embodiments. The structure illustrated by FIG. 11 is similar to the structure illustrated by FIG. 9 but with a signal contact 1010 covering and coupling both the lower source/drain region 808 and the upper source/drain region 818 with an overlying signal line 830, and descriptions of like elements are not repeated herein.

FIG. 11 illustrates an additional integration parameter D5 that may be improved upon by an AI algorithm working to improve PPAC metrics. Distance D5 is the length of a vertical portion of the signal contact 1010 between portions that couple with the upper and lower source/drain regions 808 and 818 and may determine the resistance of the tier-to-tier connection.

In another embodiment, commonly-used cost-of-merit functions are correlated to final RO-PPAC to make the automated generation of standard cells much faster while still being based on the appropriate and desired RO-PPAC metric of interest to the designer.

In another embodiment, an AI engine can challenge or test hard constraints that are present in a super-PDK. In this super-PDK, parameters typically considered locked or even assumed standard can be directly challenged to extract a new set of electrically viable layouts. These layouts can then be run through the TPS platform to derive a new set of RO-PPAC metrics. This process can be repeated multiple times to provide for an evolutionary type of learning process where one change to a usually locked parameter in the super-PDK can be made, refined, and compared with other evolutionary branches which in turn have been further improved. This may allow for determining which branch is able to provide for superior end-of-line characteristics in terms of RO-PPAC.

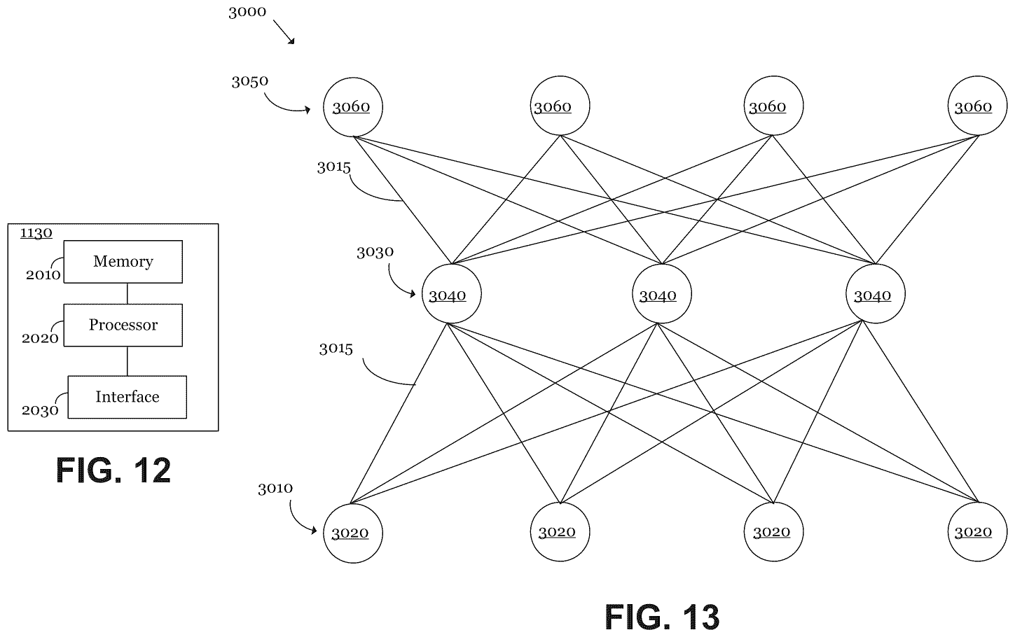

FIG. 12 illustrates a block diagram of an example machine learning (ML) system 1130 for performing methods described herein in accordance with an embodiment of the present application.

As shown, the machine learning (ML) system 1130 includes a memory 2010, a processor 2020, and an interface 2030 which may (or may not) be arranged as shown in FIG. 12.

The processor 2020 may be any component or collection of components adapted to perform the operations and computations of the ML system 1030. In one or more embodiments, in order to increase the throughput of the ML system, the processor 2020 may be implemented as a plurality of large scale graphical processing units (GPUs). For example, each individual computation of the neural network may be performed independently by the plurality of GPUs in parallel, saving overall processing time. In other embodiments the processor 2020 may be implemented as an AI supercomputer including GPU multiclusters.

In various embodiments, the processor 2020 may also be implemented as plurality of flexible programmable logic arrays (FPGAs) or application specific integrated circuits (ASICs) in order to increase the processing speed of the ML learning system 1030.

In various embodiments, the processor 2020 may be implemented as a central AI supercomputer comprising GPU multiclusters that may be connected to multiple semiconductor processing tools. In other words, the processor 2020 may be a central processor implemented to support multiple ML systems 1030. For example, machine data collected by multiple ML systems 1030 implemented on different semiconductor processing tools can send machine data to the central GPU multicluster supercomputer.

The memory 2010 may be any component or collection of components adapted to store the neural network, programming, and/or instructions for execution by the processor 2020. In one or more embodiments, the memory 2010 includes a non-transitory computer readable medium. In various embodiments, a computer-readable medium memory may include an non-transitory mechanism for storing information that can be read by a machine including read only memory (ROM), random access memory (RAM), magnetic disk storage media, optical storage media, flash-memory devices, solid state storage media, and the like.

In various embodiments, the neural network 3000 (see below, FIG. 13), RO-PPAC, the Technology Prototyping System (TPS), various TCAD models, and/or any other computational methods, tools, kits, or the like discussed in this disclosure are implemented in one or more programs stored in the memory 2010, which is then executed in the processor 2020.

Advantageously, in one or more embodiments, after the neural network 3000 is trained for the TPS, the neural network 3000 may be stored to the memory 2010 of the ML system 1130. One advantage of this is that it allows for the trained neural network to be implemented on a further ML system that may be applied with another TPS or similar program. In one or more embodiments, the further ML system may be used to run another TPS without additional training.

The interface 2030 may be any component or collection of components that allow the ML algorithm 1130 to communicate with other devices/components. For example in one or more embodiments, the interface 230 may be adapted to allow the ML system 130 to communicate with a display to inform the user of the TPS operations and/or outputs. The ML system 130 may include additional components not depicted in FIG. 12 such as long term storage (e.g., non-volatile memory, etc.).

FIG. 13 illustrates a diagram of an example neural network implemented in the machine learning system in accordance with an embodiment of the present application.

FIG. 13 illustrates a simplified diagram of a feed forward multi-layered neural network 3000 that may be implemented onto the machine learning (ML) system 1130. The neural network 3000 comprises an input layer 3010 comprising input nodes 3020, at least one hidden layer 3030 comprising hidden nodes 3040 and an output layer 3050 comprising output nodes 3060. There is no limitation on the number of input nodes 3020, hidden layers 3030, hidden nodes 3040, and output nodes 3060. Therefore, any suitable number of input nodes 3020, output nodes 3060, and hidden layers 3030 may be used. Although FIG. 13 illustrates a single neural network, the ML system 1030 may comprise multiple neural networks.

The neural network 3000 operates as a feed-forward neural networking, meaning that data always moves in a single-direction (e.g. forward) through the neural network 3000. In other words, the neural network 3000 operates by receiving inputs at the input nodes (i.e., a standard cell model) and outputting predictions (i.e., an improved standard cell model with a better PPAC metric) in terms of probabilities of an outcome at the output nodes. In one or more embodiments, the neural network 3000 may comprise an output node for every possible parameter of a super-PDK. The number of input and output nodes is not limited by this disclosure.

Although a feed-forward neural network is described herein, the neural network 3000 may be any type of suitable neural network. For example, the neural network 3000 may comprise other types of neural networks such as a recurrent neural network (RNN) or a convolutional neural network (CNN). The type of neural network used is not limited by this disclosure.

As illustrated in FIG. 3, the input nodes 3020 and each successive layer are connected using weighted connections 3015. Each weighted connection 3015 includes a unique weight that determines how relative the effect of an input is on the output. The weight values corresponding to each weighted connection 3015 is the knowledge structure of the neural network 3000. Here, learning and/or training is defined as any self-directed change of the knowledge structure of the neural network 3000 that improves performance.

The hidden nodes 3040 each implement a non-linear mathematical activation function that applies the set of weights to the input to generate a learned function. In one or more embodiments, each of the hidden nodes 3040 may apply the same non-linear activation function. In other embodiments, hidden nodes 3040 may apply different non-linear activation functions. For example non-linear activation functions may be a sigmoid function, a ReLU function or any other known non-linear activation functions known in the art.

As explained above, the neural network 3000 may be trained using labeled training data (i.e. machine data mapped to a subsequent operational code). This is known as supervised learning. A supervised learning algorithm requires, prior to labeling the training data, determining the format of the training data. In various embodiments, the format of the training data may be based of the structure of the learned function. In other words, the training data must be compatible with the learned function. Examples of learned functions may include but are not limited to, support vector based learned functions and decision tree based learned functions.

For example, in various embodiments, if the learned function is a support vector based learned function, the machine data (e.g. training data) may be formatted as an n-dimensional vector of numerical features to represent the machine data known as a feature vector. In one or more embodiments, the machine data may be formatted as a feature vector comprising the raw values of the machine data or as an image with the feature vector values comprising the pixel values of the image.

Then, in various embodiments, after determining the format of the training data and the learned function, random weights may be assigned to each weighted connection 3015 and the learned function may be initialized. In one or more embodiments, after initializing the learned function, during operation of the TPC, the mapped (“self-labeled”) standard cell model data may be fed into the neural network and used to update the learned function. In other words, based on the relationship between the training data and its respective mapping, the neural network learns, self-updates the learned function, and generates a model to predict outcomes based on inputs without mapping after sufficient training.

Techniques herein can be extended from RO-PPAC to block-level PPAC in which place-and-route capability is also factored in to provide a much larger and meaningful PPAC metric for designing standard cells. Embodiments disclosed herein also include a variety of possible integration approaches that can be pre-set in order for any suitable evolutionary change in a standard cell layout. The standard cell layout can run through multiple integration flows in which valid flows can be determined through matching back the extracted netlist to the incoming netlist used to generate the layout.

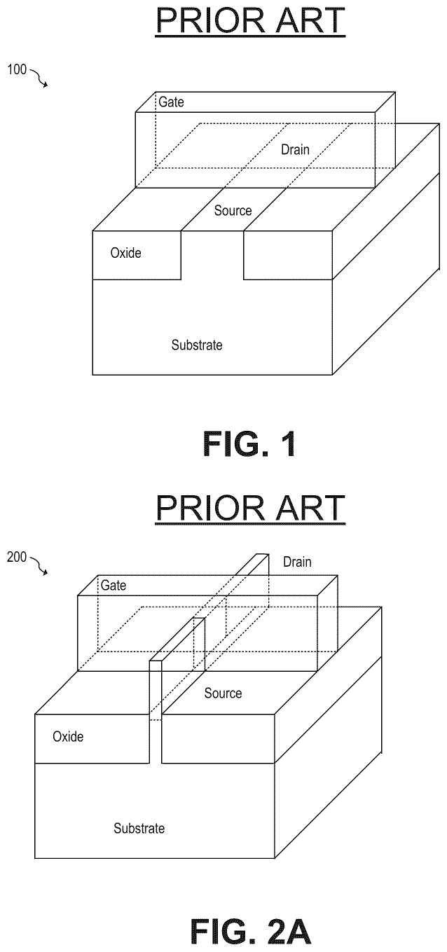

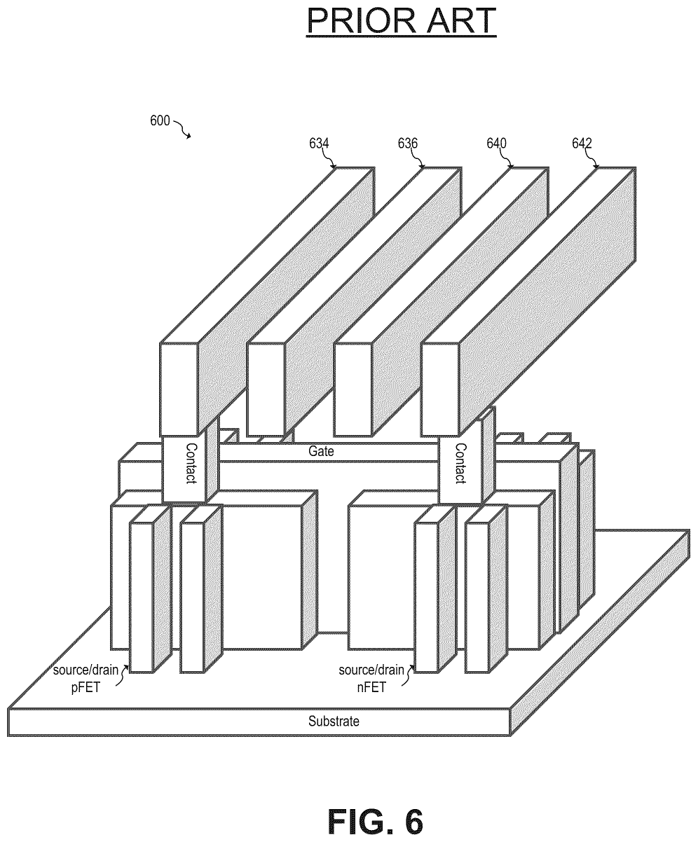

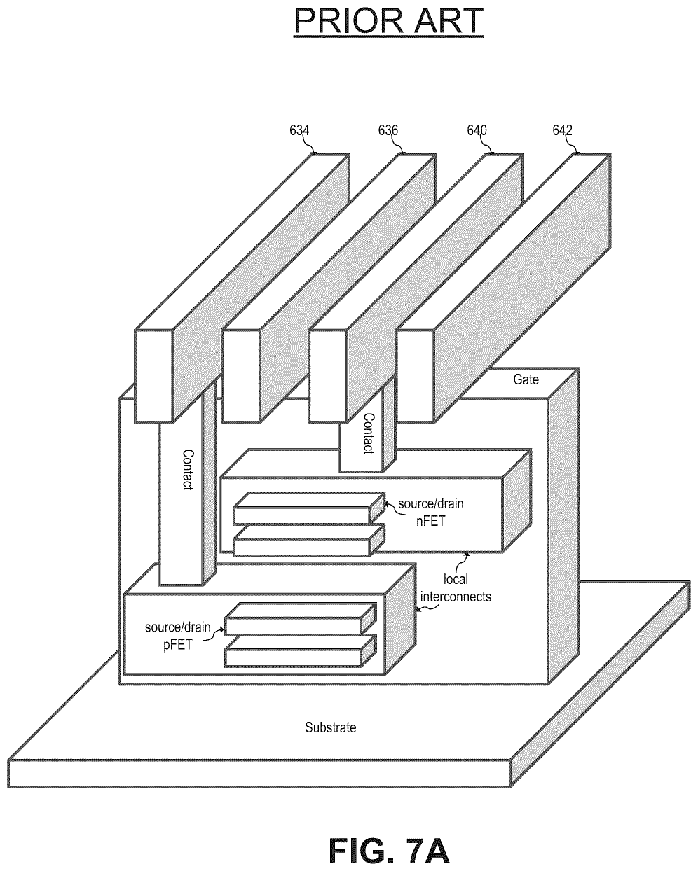

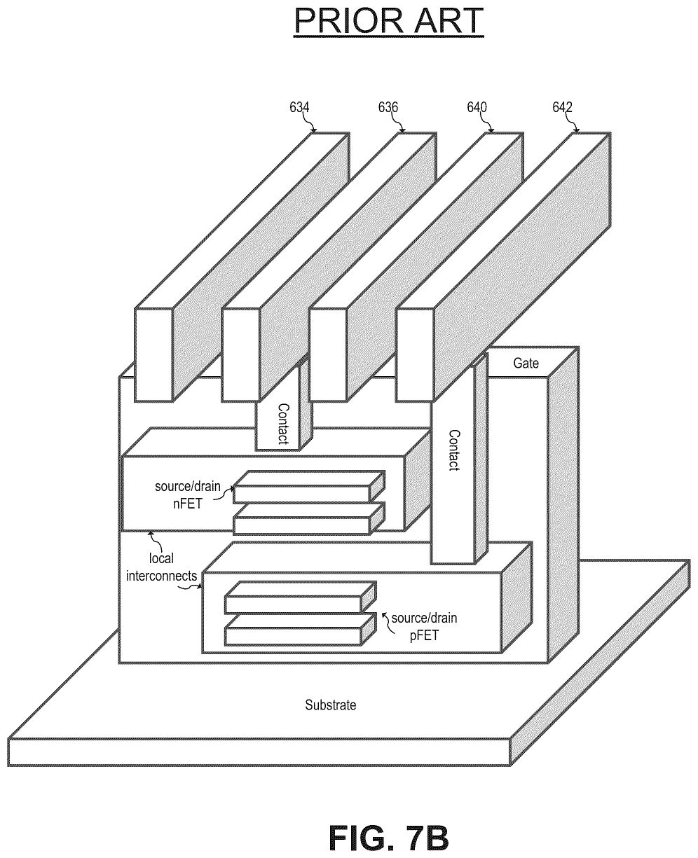

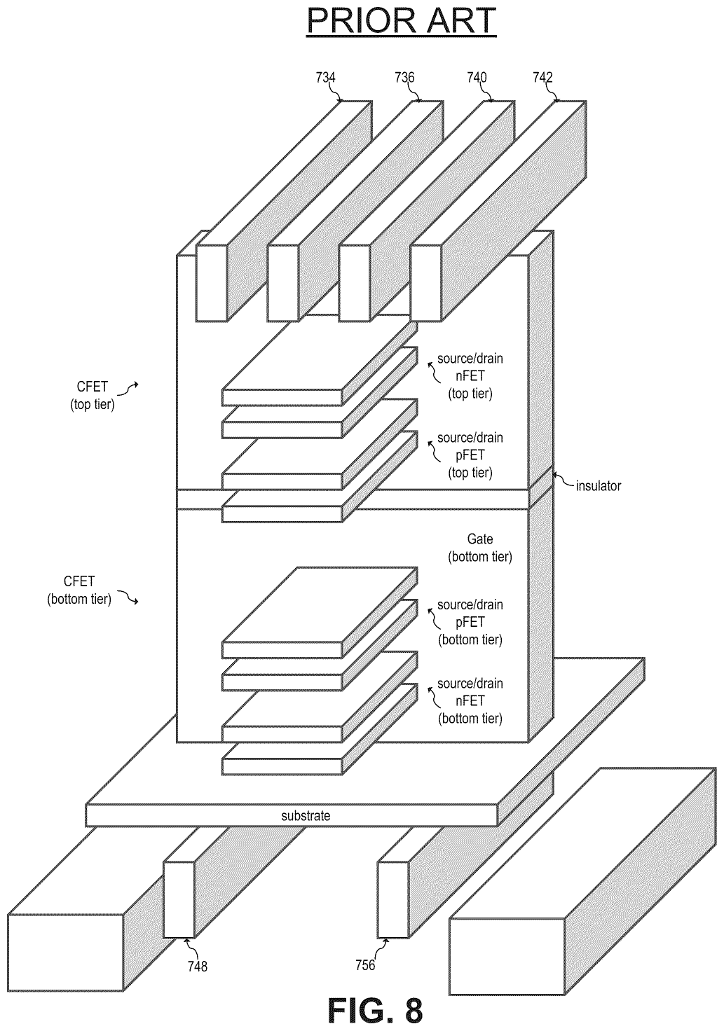

Embodiments include an initial improvement of a standard cell library through the methods identified in U.S. Pat. No. 11,550,985, incorporated herein by reference in its entirety. The initial improvement may be based on a desired output parameter that can include but is not limited to minimization of wire length, minimization of total cell height or area, minimization of metal area or volumes associated with the metal structures in the front-end-of-the-line (FEOL) or middle-of-the-line (MOL) structures such as metal gates and metal interconnects. The initial improved standard cell may be able to have its cell area extracted directly from the generated .gds or .oas file. The initial improved standard cell may be or include, but is not limited to, one or more transistor devices as described above with respect to FIGS. 1, 2A, 2B, and 3-9.

In various embodiments, a super-PDK is generated in which typical design parameters such as contacted poly pitch (CPP), gate length (Lg), effective channel width (Weff), metal size and pitch, interconnect metal widths, extensions of vias from line ends, tip-to-tip distances, or the like, are included. The super-PDK further includes additional design parameters that may not be included (in other words, are treated as fixed) in a standard such as standard cell orientation, number of standard cells, ability to float the position of power lines, or the like. The inclusion of these additional design parameters provides a means by which an AI engine (e.g., a machine learning algorithm) can apply evolutionary, non-intuitive changes to the TF, PAL, and/or PDK assumptions to look at an evolutionary-based approach to standard cell design.

Build-out of a three-dimensional electrical representation of the standard cell and device can be achieved through utilization of the Technology Prototyping System (TPS). This can use a fixed or variable process integration approach in which for any given device architecture a fixed integration may be used as a means to provide consistent comparison between different standard cell layouts and/or different process integration or device architecture methods. However, the TPS may also use a range of possible integration approaches in which any “evolutionary” change in the super-PDK input parameters can be used in conjunction with a corresponding improved standard cell layout to generate at least one extracted netlist. This extracted netlist which can then be compared directly to the incoming netlist to ensure that the generated RO-PPAC data is valid for comparison. Similarly, the step-by-step process integration can be combined with suitable software to provide estimated wafer cost for a given integration approach based on the further patterning decomposition of the standard cell layout.

Extraction of a parasitic RC netlist from the three-dimensional integration model can be combined with a TCAD model of the device obtained directly or through a suitable transistor model allowing for adjustable parameters (e.g., channel width, gate length, extension lengths, work function, threshold voltage, effective oxide thickness, the like, or a combination thereof) such as Derand Monte Carlo by Synopsys, Inc. Using such an adjustable model is advantageous for allowing the interpolation of new device model from very small permutations of existing models, which is useful for applying machine learning (ML) or another AI-generated approach to standard cell optimization. Parameters from this combination can be input into a ring oscillator (RO) simulation to provide for power and/or performance of the given standard cell layout and device integration through a range of supply voltages.

Final output of the RO-PPAC (power/performance/area/cost) can be adjusted to provide for the desired target of the designer in terms of the standard cell improvement, such as but not limited to, cost-per-performance, or performance-as-function-of-power. The desired post-RO-PPAC output can then be used to determine which electrically valid standard cell solutions are desirable based on a full simulation analysis rather than on parameters easily extracted from the .gds or .oas generated file such as wire length, metal area and/or volumes, total standard cell height, etc.

Embodiments include a software model which can increase the speed of the automated standard cell generation through establishing a correlation between easily extractable parameters from the .gds and .oas files such as wire length, metal area and/or volume, total cell height on finalized RO-PPAC metrics such that the correlation can be used as either a Monte Carlo or interpolative response to changes made to the standard cell layout.

Embodiments include methodology in which the learning from the desired post RO-PPAC output can be applied to guiding further iterations of the standard cell design to weigh in favor of more critical parameters. Embodiments include a method to extract from a complicated parasitic RC extraction key resistance and capacitance metrics influencing power and performance of the simulated device to guide further iterations of the standard cell design to weight in favor of more critical parameters.

Embodiments include further extension of this method from a simple RO-PPAC based metric to full block-level PPAC metrics through incorporating a full place-and-route into a chip architecture design and subsequently extracting block-level PPAC with feed-back going back into the standard cell generation loop.

Embodiments include methodology for an AI engine to challenge or change constructs in the super-PDK which might otherwise be considered locked, assumed valid, or unworthy of being adjusted by current practices, in order to quickly explore different evolutionary branches of such changes. It is understood that the typical changing of parameters would likewise be allowed such as transistor placement and wiring connections as is currently done in automated improvement of standard cells. One change can be made to the super-PDK with a full RO-PPAC based improvement of the standard cell layout with the finalized metric of choice being fully improved. Next, a subsequent evolutionary change can be made, and the process may be continued. A full evolutionary branch-to-branch comparison of finalized RO-PPAC data can then be used to identify stronger evolutionary branches over others. This feedback can then be supplied back to designers and integration experts to improve the process integration around these evolutionary changes in the standard cell design. With each subsequent improved standard cell, the process is looped in which RO-PPAC data is used to further improve the standard cell layout. These improved standard cells may then go through a full extraction process to generate their own respective RO-PPAC outputs.

Embodiments include methodology where after an improved standard cell layout is generated, machine learning (ML) and/or other AI aspects are used to challenge the process assumptions and material characteristics used in the initial generated model. From these changes, the software is configured to redetermine a new improved standard cell layout. This process is repeated until some saturation of improvement based upon RO-PPAC metrics is reached. Additionally, different branches of standard cell optimization done from multiple process assumption changes may be configured to effectively compete against one another until they reach a saturated state in which the results of one branch of standard cell optimization can be compared to the other. An AI algorithm is trained to come up with its own permutation space through the parameterization of every single component of the cell design and process assumptions, including assumptions that are usually fixed in a standard cell design. The AI algorithm may be further configured to provide feedback to a human operator on how permutations in either the layout, design, or integration provide a significant benefit with requests for the human operator to check if the permutation is physically realistic.

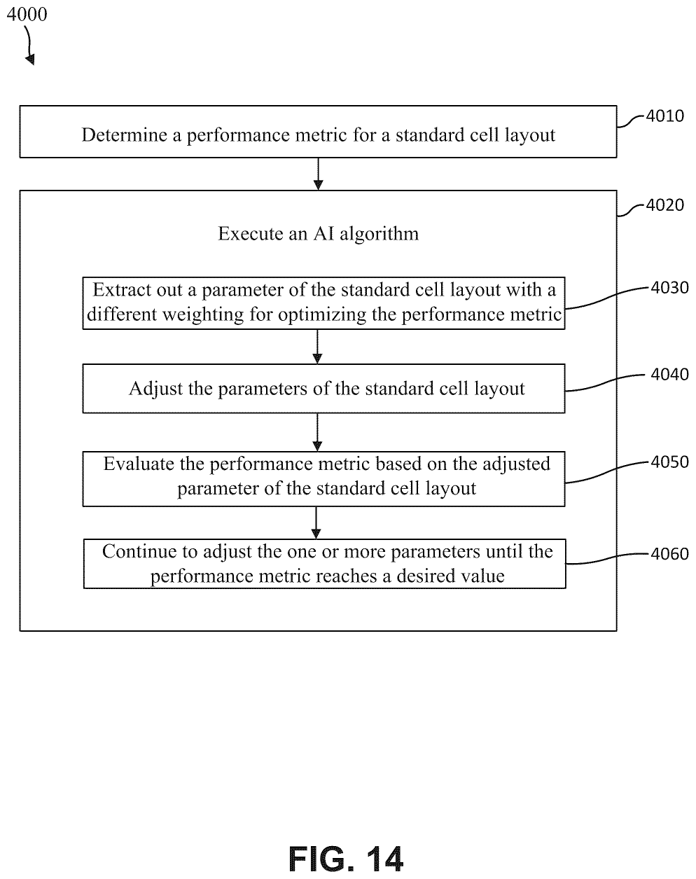

FIG. 14 illustrates a process flow chart diagram of a method 4000 of designing a standard cell layout, in accordance with some embodiments. In step 4010, a performance metric is determined the standard cell layout. In step 4020, an artificial intelligence (AI) algorithm is executed, which comprises steps 4030, 4040, 4050, and 4060.

In step 4030, a parameter of the standard cell layout having a different weighting with respect to optimizing the performance metric is extracted out. In step 4040, the parameters of the standard cell layout are adjusted. In step 4050, the performance metric is evaluated based on the adjusted parameter of the standard cell layout. In step 4060, the AI algorithm continues to adjust the one or more parameters until the performance metric reaches a desired value.

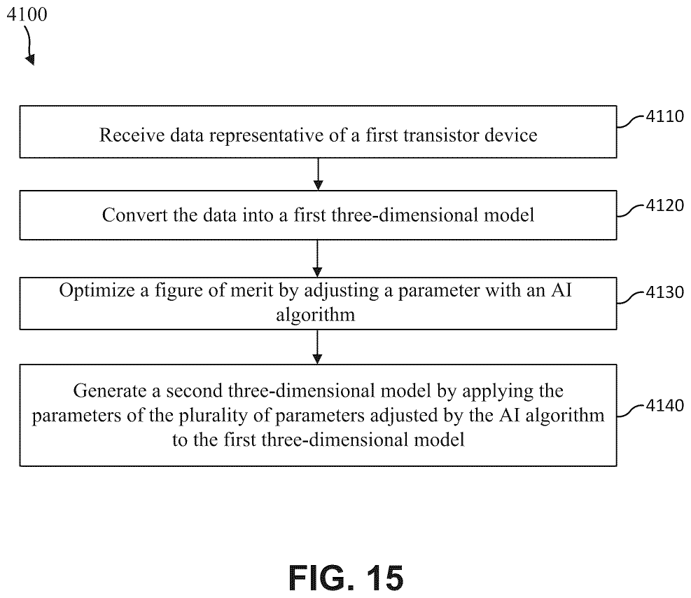

FIG. 15 illustrates a process flow chart diagram of a method 4100 of designing a semiconductor device, in accordance with some embodiments. In step 4110, data representative of a first transistor device is received. In step 4120, the data is converted into a first three-dimensional model. The first three-dimensional model comprises a plurality of parameters representing locations and dimensions of features of the first transistor device and a first figure of merit representing at least one of power, performance, area, and cost.

In step 4130, the first figure of merit is optimized by adjusting one or more of the plurality of parameters using an artificial intelligence (AI) algorithm. In step 4140, a second three-dimensional model is generated by applying the parameters of the plurality of parameters adjusted by the AI algorithm to the first three-dimensional model. The second three-dimensional model is representative of a physical manifestation of a second transistor device.

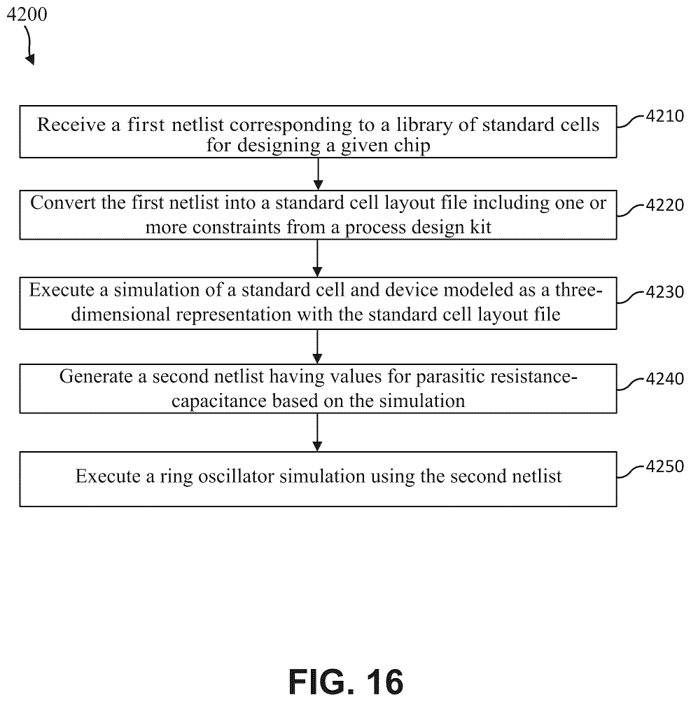

FIG. 16 illustrates a process flow chart diagram of a method 4200 of designing a standard cell layout, in accordance with some embodiments. In step 4210, a first netlist corresponding to a library of standard cells for designing a given chip is received. In step 4220, the first netlist is converted into a standard cell layout file including one or more constraints from a process design kit. The process design kit is configured to model a semiconductor fabrication process.

In step 4230, a simulation of a standard cell and device modeled as a three-dimensional representation with the standard cell layout file is executed. In step 4240, a second netlist having values for parasitic resistance-capacitance is generated based on the simulation. In step 4250, a ring oscillator simulation is executed using the second netlist. The ring oscillator simulation generates a performance metric that includes at least one of power, performance, area, and cost for a corresponding integration flow.

Embodiments include software-enabled generation of a set of viable standard cell layouts based on a provided circuit netlist input in addition to either a technology file, process assumption list, and/or process development kit (PDK).

Embodiments include a method for incorporating simulated modelling and prediction of cell-level ring oscillator power/performance/area/cost (RO-PPAC) characteristics from each individually generated layout utilizing a three-dimensional model of the semiconductor device adhering to the constraints provided by the technology file, process assumption kit, and/or PDK utilizing generated TCAD device models, parasitic netlist including all parasitic capacitance and resistances within the device, and generated compact and HSPICE models.

Embodiments include a method for incorporating variability modelling of established parameters within the semiconductor device in order to simulate design corners for cach viable generated standard cell layout based on a simulated device model. Desired place-and-route (PnR) solutions may be subsequently modelled.

Embodiments include a method of establishing a hierarchical merit cost function output defined by the user for power/performance/area/cost (PPAC) and other metrics that can be set by the user for each standard layout. The hierarchical merit cost function can be extended from an individual standard cell layout to a full complex library of standard cells incorporating the same set of constraints provided by the technology file, process assumption lists, and/or PDK. Multiple sub-libraries may be permitted in order to have different optimized solutions possible for different sets of standard cells. For example, an unique standard cell solution can be obtained for high-density standard cells in which it is desired to have minimum overall area while also obtaining an unique standard cell solution for high-performance devices in which cell-level performance is optimized. Multiple sub-library solutions be hierarchically ranked in terms of overall chip-level power/performance/area/cost (PPAC) benefit.

Embodiments include a method for incorporating machine learning models to extract out parameters of a standard cell design that have different weighting with respect to the desired merit cost function optimization. For example, the machine learning algorithm may determine that overlap lengths between adjacent metal gates and metal contacts have a dominant or most dominant influence over total cell-level capacitance, and in subsequent standard cell design variation runs the machine learning algorithm may favor those which minimize this parameter. Incorporating the machine learning aspect may allow for permutations of possible standard cells to be modelled fully through the power/performance/area/cost (PPAC) that would be favorable to generating a positive cost merit function as opposed to employing a brute-force method in which every possible permutation of standard cell is evaluated.

Embodiments include a method for taking incoming technology files, process assumption lists, and/or PDK and parameterizing each and every individual component into potential pieces which can be varied in order to search for further optimization of the desired cost merit function.

Embodiments include a method for incorporating AI-generated approaches to add variation to each parameter of the tech file, PDK, and/or process assumption list either separately or integrally in order to re-optimize a standard cell solution based on a desired cost merit function.

Embodiments include a method for forming multiple sequential parameter changes along one evolutionary branch in order to make subsequent generations from an initial base assumption change.

Embodiments include a method for running multiple branches simultaneously in order to provide some differentiation where the optimized cost function of one branch may saturate out while other branches show continued improvement while favoring extension of continued design evolution along branches which show favorable results from the cost merit function.

Embodiments include a method for providing some level of ‘sanity checking’ in which the software or AI can provide suggestions for possible changes of the listed parameters and inquire about the possibility (e.g., querying a human operator) before continuing down these evolutionary branches. For example, the software can inquire if a parameter such as individually adjusting the NMOS and PMOS nanosheet widths are possible for a given device architecture before continuing along that one evolutionary branch.

Embodiments include a method for co-optimizing layout and integration process assumptions both sequentially and simultaneously. For example, when the machine learning has a local optimization of the standard cell layout design, it can then look at optimizing specific parameters in the device integration file to further improve power/performance/area/cost (PPAC) without any additional changes to the actual layout as a co-optimized solution. Additionally, for any change in the device process integration made to optimize it for a given set standard cell layout, the integration optimization may then be re-run through a standard cell-level optimization to further drive any improvement in the desired cost merit function.

Embodiments include a method for allowing the machine learning and/or AI to substitute a range of material characteristics, device elements, and electrical characteristics in order to provide some readout of direction of how each of these components could be used to further drive improvement in the cost merit function. For example, the machine learning could determine an optimum performance/cost metric based on a given contact resistance and then predict how further improvements in the contact resistance numbers would improve this specific layout. The machine learning could then also generate a new optimized layout solution in order to provide any benefit to the final desired performance/cost metric.

Embodiments include the machine learning or other AI algorithm looking at segregating the standard cell into sub-sections as a variable parameter such that smaller double-high standard cells can be compared against conventional single-high standard cells. Embodiments also include the machine learning or other AI algorithm looking at comparing transistor-on-transistor three-dimensional stacking options of a standard cell in a CFET device architecture and comparing it against a more conventional CFET device approach.

Embodiments include methodology for extending the machine learning and AI capability from standard cell and standard cell libraries to full-level chip and system-on-chip design including various optimized solutions for chiplet stacking.

Example embodiments of the disclosure are summarized here. Other embodiments can also be understood from the entirety of the specification as well as the claims filed herein.

Example 1. A method of designing a standard cell layout, the method including: determining a performance metric for the standard cell layout; and executing an artificial intelligence (AI) algorithm, the executing of the AI algorithm including: extracting out a parameter of the standard cell layout having a different weighting with respect to optimizing the performance metric; adjusting the parameters of the standard cell layout; evaluating the performance metric based on the adjusted parameter of the standard cell layout; and continuing to adjust the one or more parameters until the performance metric reaches a desired value.

Example 2. The method of example 1, where the performance metric represents at least one of power, performance, area, and cost.

Example 3. The method of example 2, where the AI algorithm models permutations of a standard cell design using the performance metric without evaluating every possible permutation of the standard cell design.

Example 4. The method of one of examples 1 to 3, where the parameter of the standard cell layout is an overlap length between adjacent metal gates and metal contacts.

Example 5. The method of one of examples 1 to 4, where the standard cell layout is generated based on a circuit netlist input and a technology file, process assumption list, or process development kit (PDK).

Example 6. The method of example 5, where the AI algorithm is further configured to incorporate simulated modelling and prediction of cell-level ring oscillator power, performance, area, or cost (PPAC) characteristics from the standard cell layout using a three-dimensional model of a semiconductor device based on constraints from a technology file, process assumption list, or process development kit (PDK) with a parasitic netlist including all parasitic capacitances and resistances within the semiconductor device.

Example 7. The method of example 6, where the performance metric for the standard cell layout is extendable to a library of standard cells incorporating the constraints from the technology file, process assumption list, or process development kit (PDK).

Example 8. The method of example 7, where different optimized solutions are allowed for respective sets of standard cells in the library of standard cells.

Example 9. The method of one of examples 1 to 8, where the AI algorithm is further configured to perform multiple sequential parameter changes along one evolutionary branch of modifications to the standard cell layout.

Example 10. The method of one of examples 1 to 9, where the AI algorithm is further configured to improve the performance metric by substituting a range of material characteristics, device elements, and electrical characteristics in a model of a semiconductor device.

Example 11. The method of example 10, where the AI algorithm is configured to determine a new layout that improves the performance metric by changing a contact resistance of the layout.

Example 12. The method of one of examples 1 to 11, where the AI algorithm includes a machine learning system.

Example 13. A method of designing a transistor device, the method including: receiving data representative of a first transistor device; converting the data into a first three-dimensional model, the model including: a plurality of parameters representing locations and dimensions of features of the first transistor device; and a first figure of merit representing at least one of power, performance, area, and cost; optimizing the first figure of merit by adjusting one or more of the plurality of parameters using an artificial intelligence (AI) algorithm; and generating a second three-dimensional model by applying the parameters of the plurality of parameters adjusted by the AI algorithm to the first three-dimensional model, the second three-dimensional model being representative of a physical manifestation of a second transistor device.

Example 14. The method of example 13, where the first transistor device is a complementary FET (CFET).

Example 15. The method of example 14, where the CFET is a two-tier stacked CFET.

Example 16. The method of one of examples 13 to 15, where the second transistor device is part of a ring oscillator.

Example 17. A method of designing a standard cell layout, the method including: receiving a first netlist, the first netlist corresponding to a library of standard cells for designing a given chip; converting the first netlist into a standard cell layout file including one or more constraints from a process design kit, the process design kit being configured to model a semiconductor fabrication process; executing a simulation of a standard cell and device modeled as a three-dimensional representation with the standard cell layout file; based on the simulation, generating a second netlist having values for parasitic resistance-capacitance; and executing a ring oscillator simulation using the second netlist, the ring oscillator simulation generating a performance metric that includes at least one of power, performance, area, and cost for a corresponding integration flow.

Example 18. The method of example 17, where the second netlist is generated using an artificial intelligence (AI) algorithm.

Example 19. The method of example 18, where the AI algorithm is configured to adjust one or more constraints not part of the process design kit.

Example 20. The method of example 19, where the one or more constraints not part of the process design kit include gate length, contacted poly pitch, or effective channel width.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of designing a standard cell layout, the method comprising:
determining a performance metric for the standard cell layout; and
executing an artificial intelligence (AI) algorithm, the executing of the AI algorithm comprising:
extracting out a parameter of the standard cell layout having a different weighting with respect to optimizing the performance metric;
adjusting the parameters of the standard cell layout;
evaluating the performance metric based on the adjusted parameter of the standard cell layout; and
continuing to adjust the one or more parameters until the performance metric reaches a desired value.

2. The method of claim 1, wherein the performance metric represents at least one of power, performance, area, and cost.

3. The method of claim 2, wherein the AI algorithm models permutations of a standard cell design using the performance metric without evaluating every possible permutation of the standard cell design.

4. The method of claim 1, wherein the parameter of the standard cell layout is an overlap length between adjacent metal gates and metal contacts.

5. The method of claim 1, wherein the standard cell layout is generated based on a circuit netlist input and a technology file, process assumption list, or process development kit (PDK).

6. The method of claim 5, wherein the AI algorithm is further configured to incorporate simulated modelling and prediction of cell-level ring oscillator power, performance, area, or cost (PPAC) characteristics from the standard cell layout using a three-dimensional model of a semiconductor device based on constraints from a technology file, process assumption list, or process development kit (PDK) with a parasitic netlist including all parasitic capacitances and resistances within the semiconductor device.

7. The method of claim 6, wherein the performance metric for the standard cell layout is extendable to a library of standard cells incorporating the constraints from the technology file, process assumption list, or process development kit (PDK).

8. The method of claim 7, wherein different optimized solutions are allowed for respective sets of standard cells in the library of standard cells.

9. The method of claim 1, wherein the AI algorithm is further configured to perform multiple sequential parameter changes along one evolutionary branch of modifications to the standard cell layout.

10. The method of claim 1, wherein the AI algorithm is further configured to improve the performance metric by substituting a range of material characteristics, device elements, and electrical characteristics in a model of a semiconductor device.

11. The method of claim 10, wherein the AI algorithm is configured to determine a new layout that improves the performance metric by changing a contact resistance of the layout.

12. The method of claim 1, wherein the AI algorithm comprises a machine learning system.

13. A method of designing a transistor device, the method comprising:
receiving data representative of a first transistor device;
converting the data into a first three-dimensional model, the model comprising:
a plurality of parameters representing locations and dimensions of features of the first transistor device; and
a first figure of merit representing at least one of power, performance, area, and cost;
optimizing the first figure of merit by adjusting one or more of the plurality of parameters using an artificial intelligence (AI) algorithm; and
generating a second three-dimensional model by applying the parameters of the plurality of parameters adjusted by the AI algorithm to the first three-dimensional model, the second three-dimensional model being representative of a physical manifestation of a second transistor device.

14. The method of claim 13, wherein the first transistor device is a complementary FET (CFET).

15. The method of claim 14, wherein the CFET is a two-tier stacked CFET.

16. The method of claim 13, wherein the second transistor device is part of a ring oscillator.

17. A method of designing a standard cell layout, the method comprising:
receiving a first netlist, the first netlist corresponding to a library of standard cells for designing a given chip;
converting the first netlist into a standard cell layout file including one or more constraints from a process design kit, the process design kit being configured to model a semiconductor fabrication process;
executing a simulation of a standard cell and device modeled as a three-dimensional representation with the standard cell layout file;
based on the simulation, generating a second netlist having values for parasitic resistance-capacitance; and
executing a ring oscillator simulation using the second netlist, the ring oscillator simulation generating a performance metric that includes at least one of power, performance, area, and cost for a corresponding integration flow.

18. The method of claim 17, wherein the second netlist is generated using an artificial intelligence (AI) algorithm.

19. The method of claim 18, wherein the AI algorithm is configured to adjust one or more constraints not part of the process design kit.

20. The method of claim 19, wherein the one or more constraints not part of the process design kit comprise gate length, contacted poly pitch, or effective channel width.
